(19) United States
(12) Patent Application Publication
(10) Pub. No.: US 2025/0237746 A1
(43) Pub. Date: Jul. 24, 2025

(54) LiDAR using Multi-Junction Laser Diodes

(71) Applicant: SemiNex Corporation, Danvers, MA (US)

(72) Inventors: Sidi Aboujja, Middleton, MA (US); Daniel Yen Chu, Andover, MA (US); Ronald Moore, Boxford, MA (US)

(21) Appl. No.: 18/756,266

(22) Filed: Jun. 27, 2024

Related U.S. Application Data
(60) Provisional application No. 63/624,580, filed on Jan. 24, 2024.

(51) Int. Cl. G01S 7/481; G01S 7/484; G01S 7/4861

(52) U.S. Cl. CPC G01S 7/4814; G01S 7/4817; G01S 7/484; G01S 7/4861

(57) ABSTRACT

A time-of-flight LiDAR system that uses multi-junction laser diodes, for higher peak power than a single junction laser diode can provide, will provide in greater range capability for the LiDAR system. An additional approach to extending range is to continue to increase the output power of the transmitter using multi-junction semiconductor optical amplifiers. In addition to increasing the output power of the laser transmitter, it is also possible to increase the sensitivity of the receiver by using a single junction semiconductor optical amplifier. Finally, operating the pulsed system with an injection locked multi-junction transmitter and a coherent receiver greatly increases the sensitivity of the receiver.

### RELATED APPLICATIONS

This application claims the benefit under 35 USC 119(e) of U.S. Provisional Application No. 63/624,580, filed on Jan. 24, 2024, which is incorporated herein by reference in its entirety.

### BACKGROUND OF THE INVENTION

LiDAR refers to Light Detection and Ranging and can be accomplished with pulsed laser sources. This prior art will concentrate on the time-of-flight pulsed LiDAR systems. The projected market for this technology will exceed $8.4B over the next 10 years, but to achieve that growth, several shortcomings must be overcome. The LIDAR system operates by using a short high peak power pulse emitted by the transmitter followed by listening for the return from the object being tested for range. The time delay between the emitted pulse and the received pulse is a direct measure of the range. The shorter the pulse the better the range resolution, while the peak power of the pulse determines the effective range of the LiDAR system which can vary under atmospheric conditions. When designing a system, the LiDAR system must have sufficient peak power and a sufficiently short pulse length to achieve the desired performance of the system.

The primary concern for automotive applications is the cost of the unit, while a fiber laser can provide very high peak power levels at the requisite pulse width, the cost of the system is high because the fiber laser must have multiple laser diodes pumping the fiber and the fiber laser is a resonator so it must have gratings embedded in the fiber as well as endcaps and mode strippers. All these elements result in the high cost of the fiber laser. A semiconductor laser is the ideal “low cost” solution; however, today's single junction laser diodes are limited in their output power and beam quality to power levels less than 30 Watts (@908 nm) for pulse widths less than 100 nsec. This limitation is the specifications that can be achieved with reliable performance, while higher power levels are possible, these devices will have a much shorter lifespan than the applications demand. To achieve greater output power levels multiple laser diodes have been mounted adjacent to each other into a single package. This approach limits the brightness of the laser source because of the distance between each emitter to achieve power levels up to 100 Watts (5 diodes @25 Watts each). See OSI Laser Diode Inc, CVD 68, CVD 167, www.laserdiode.com.

### SUMMARY OF THE INVENTION

The invention is a time-of-flight LiDAR system that uses multi-junction laser diodes for higher peak power than a single junction laser diode can provide, which will result in greater range capability for the LiDAR system. An additional approach to extending range is to continue to increase the output power of the transmitter using multi-junction semiconductor optical amplifiers. In addition to increasing the output power of the laser transmitter, it is also possible to increase the sensitivity of the receiver by using a single junction semiconductor optical amplifier. Finally, operating the pulsed system with an injection locked multi-junction transmitter and a coherent receiver greatly increases the sensitivity of the receiver. Overall, these improvements to today's LiDAR systems will result in a significant increase in range capability.

In accordance with the present invention, LiDAR systems as set forth in the independent claims, respectively, are provided. Preferred embodiments of the inventions are described in the dependent claims.

In addition, in accordance with the present invention, the following LiDAR systems are further featured:
1) A time-of-flight LIDAR system that uses a multi-junction laser diode as the laser source where n is the number of junctions and n>1 and a multi-junction semiconductor optical amplifier where m is the number of junctions and m≥n to increase the peak output power of the laser transmitter.
2) The LiDAR system of claim 1 using a single transverse stripe with multi-junctions in the epi-layers to provide greater power and brightness than a single junction where n is the number of junctions and n>1.
3) The LiDAR system of claim 1 using a single transverse stripe with multi-junctions in the epi-layers to provide higher output power than a single junction and where n junctions are used in the primary laser and m junctions are used in the semiconductor optical amplifier with m≥n>1. The semiconductor optical amplifier has AR coated front and back facets where the AR coating is 1% or less reflectivity. The waveguides are tilted at an angle of 4 degrees or greater with respect to the normal to the device output or input facet to further reduce feedback into the amplifier.
4) The LiDAR system of claim 1 where the multi-junction laser source can have a wavelength from 1225 nm to 1700 nm.
5) The LiDAR system of claim 1 that uses a polygon scanner to scan the transmitted laser beam and receive the transmitted laser beam producing a 3-dimensional representation of the field of view.
6) The LiDAR system of claim 1 that uses a Risley prism pair to scan the transmitted laser beam and receive the transmitted laser beam producing a 3-dimensional representation of the field of view.
7) The LiDAR system of claim 1 that uses a vibrating mirror to scan the transmitted laser beam and receive the transmitted laser beam producing a 3-dimensional representation of the field of view.
8) The LiDAR system of claim 1 that can be mounted on a rotating platform with either a Risley prism pair, a vibrating mirror or a polygon scanner to provide a 3-dimensional representation of the field of view.
9) The LiDAR system of claim 1 that determines the range of an object in the field of view.
10) The LiDAR system of claim 1 that can also double as a target designator.
11) The LiDAR system of claim 1 that uses an Avalanche Photo diode as a receiver.
12) The LiDAR system using a multi-junction laser diode of claim 1 that has a Bragg Grating etched on the top layer to control wavelength over a wide temperature range.
13) The LiDAR system using a multi-junction laser diode of claim 1 that uses a tapered semiconductor optical amplifier as the high-power section of the multi-junction high power semiconductor optical amplifier.
14) The LiDAR system using a multi-junction laser diode of claim 1 that uses a tapered semiconductor optical amplifier as the high-power section of the multi-junction high power semiconductor optical amplifier and a Bragg Grating stabilized master oscillator integrated on the same chip with feedback isolation trenches.
15) The LiDAR of claim 1 uses multiple multi-junction laser diodes and multi-junction semiconductor optical amplifiers on a single chip where I is the number of laser diodes and I>1 to increase the output power of the source.
16) The LiDAR system of claim 1 uses multiple individually addressable multi-junction lasers and multi-junction semiconductor optical amplifiers on a single chip where I is the number of individually addressable laser diodes and I>1 to provide electronic beam steering.
17) The LiDAR system using a multi-junction laser diode and multi-junction semiconductor optical amplifiers of claim 1 that is integrated into a Silicon Photonic Integrated circuit to provide a complete LiDAR solution on a single chip.
18) The LiDAR system using a multi-junction laser diode of claim 1 that uses a grating in an external cavity in Littrow to narrow and stabilize the wavelength of the laser source over a temperature range and the stabilized output beam is coupled into the multi-junction semiconductor optical amplifier.
19) The LiDAR system of claim 1 that uses a MEMs device to steer the beam over the field of regard.
20) The LiDAR system of claim 1 that is configured as an optical phase array and is electronically steered over the field of view.
21) The LiDAR system of claim 1 that uses a micro-optic, a binary optic, a diffractive optic, a holographic optic, a micro-prism arrangement, or an Axicon to compensate for the displacement of the junctions from the axis of the primary collimating optic to create parallel, collimated output beams.
22) The LiDAR system of claim 1 using a Bragg Grating stabilized multi-junction source and a method to sample the master oscillator beam and mix it with the return beam to enable coherent detection on a double balanced receiver for the time-of-flight pulse.
23) The LiDAR system of claim 1 where a master oscillator is used to injection lock the multi-junction semiconductor optical amplifier creating mutually coherent beams from each laser of the multi-junction source.
24) The LiDAR system of claim 1 where the master oscillator, power splitting waveguide and power semiconductor optical amplifier are integrated on the same semiconductor material and the power semiconductor optical amplifier is independently biased from the master oscillator/power splitter section.
25) The LiDAR system of claim 1 where the semiconductor optical amplifiers have low anti-reflection coatings on the input and the output facets of 1% or less reflectivity.
26) The LiDAR system of claim 1 where the semiconductor optical amplifiers are at an angle to the input and the output facets where the angle is 4°, 5°, or more and the facets have a low anti-reflection coating of 1% or less reflectivity.
27) The LiDAR system of claim 1 where the semiconductor optical amplifier has a curved waveguide so the master can be injected orthogonal to the back facet while exiting at an angle of 4°, 5°, or more and the facets have a low anti-reflection coating.
28) The LiDAR system of claim 1 where the semiconductor optical amplifier has multiple curved waveguides, where s is the number of curves and s>1, that allow the beam to exit out of any facet including the back facet where the angle is 0°, 4°, 5°, or more and the facets have a low anti-reflection coating of 1% or less reflectivity.
29) A time-of-flight LiDAR system that uses a multi-junction laser diode as the laser source where n is the number of junctions and n>1 and a single junction semiconductor optical amplifier as a pre-amplifier to the receiver with a narrow bandpass filter to block the broadband spontaneous emission from the semiconductor optical amplifier from reaching the photodetectors.
30) The LiDAR system of claim 29 using a single transverse stripe with multi-junctions in the epi-layers to provide higher output power than a single junction and where n junctions are used in the primary laser and m junctions are used in the amplifier with m≥n>1.
31) The LIDAR system of claim 29 where the multi-junction laser source can have a wavelength from 1225 nm to 1700 nm.
32) The LiDAR system of claim 29 that uses a polygon scanner to scan the transmitted laser beam and receive the transmitted laser beam producing a 3-dimensional representation of the field of view.
33) The LiDAR system of claim 29 that uses a Risley prism pair to scan the transmitted laser beam and receive the transmitted laser beam producing a 3-dimensional representation of the field of view.
34) The LiDAR system of claim 29 that uses a vibrating mirror to scan the transmitted laser beam and receive the transmitted laser beam producing a 3-dimensional representation of the field of view.
35) The LiDAR system of claim 29 that can be mounted on a rotating platform with either a Risley prism pair, a vibrating mirror or a polygon scanner to provide a 3-dimensional representation of the field of view.
36) The LiDAR system of claim 29 that determines the range of an object in the field of view.
37) The LiDAR system of claim 29 that can also double as a target designator.
38) The LiDAR system of claim 29 that uses an Avalanche Photo diode as a receiver.
39) The LiDAR system using a multi-junction laser diode of claim 29 that has a Bragg Grating etched on the top layer to control wavelength over a wide temperature range.
40) The LiDAR system using a multi-junction laser diode of claim 29 that uses a multi-junction tapered semiconductor optical amplifier as the high-power laser transmitter.
41) The LiDAR system using a multi-junction laser diode of claim 29 that uses a tapered semiconductor optical amplifier as the high-power laser transmitter and a Bragg Grating stabilized master oscillator integrated on the same chip with feedback isolation trenches.
42) The LiDAR system of claim 29 uses multiple multi-junction laser diodes on a single chip where I is the number of laser diodes and I>1 to increase the output power of the source.
43) The LiDAR system of claim 29 uses multiple individually addressable multi-junction laser diodes on a single chip where I is the number of individually addressable laser diodes and I>1 to provide an electronic beam steering.
44) The LiDAR system using a multi-junction laser diode of claim 29 that is integrated into a Silicon Photonic Integrated circuit to provide a complete LIDAR solution on a single chip.
45) The LiDAR system using a multi-junction laser diode of claim 29 that uses a grating in an external cavity in Littrow to narrow and stabilize the wavelength of the laser source over a temperature range and the stabilized output beam is coupled into the multi-junction semiconductor optical amplifier.
46) The LiDAR system of claim 29 that uses a MEMs device to steer the beam over the field of regard.
47) The LiDAR system of claim 29 that is configured as an optical phase array and is electronically steered over the field of view.
48) The LiDAR system of claim 29 that uses an optical element such as a micro-optic, binary optic, diffractive optic, a holographic optic, a micro-prism arrangement or an Axicon to simultaneously inject the master oscillator signal into each of the multi-junction lasers or semiconductor optical amplifiers making them mutually coherent.
49) The LiDAR system of claim 29 that uses a micro-optic, a binary optic, a diffractive optic, a holographic optic, a micro-prism arrangement, or an Axicon to compensate for the displacement of the junctions from the axis of the primary collimating optic to create parallel, collimated output beams.
50) The LiDAR system of claim 29 using a Bragg Grating stabilized laser source and a method to sample the master oscillator beam and mix it with the return beam to enable coherent detection on a double balanced receiver for the time-of-flight pulse.
51) The LiDAR system of claim 29 where a master oscillator is used to injection lock the multi-junction source creating mutually coherent beams from each laser of the multi-junction source.
52) The LiDAR system of claim 29 where the master oscillator, power splitting waveguide and power semiconductor optical amplifier are integrated on the same semiconductor material and the power semiconductor optical amplifier is independently biased from the master oscillator/power splitter section.
53) The LiDAR system of claim 29 where the semiconductor optical amplifiers have low anti-reflection coatings on the input and the output facets of 1% or less reflectivity.
54) The LiDAR system of claim 29 where the semiconductor optical amplifiers are at an angle to the input and the output facets where the angle is 4°, 5°, or more and the facets have a low anti-reflection coating of 1% or less reflectivity.
55) The LiDAR system of claim 29 where the semiconductor optical amplifier has a curved waveguide so the master can be injected orthogonal to the back facet while exiting at an angle of 4°, 5°, or more and the facets have a low anti-reflection coating.
56) The LiDAR system of claim 29 where the semiconductor optical amplifier has multiple curved waveguides, where s is the number of curves and s>1 that allow the beam to exit out of any facet including the back facet where the angle is 0°, 4°, 5°, or more and the facets have a low anti-reflection coating of 1% or less reflectivity.
57) A time-of-flight LiDAR system that uses a multi-junction laser diode and a multi-junction semiconductor optical amplifier where n is the number of junctions and n>1 to increase the peak output power of the laser transmitter and a single junction semiconductor optical amplifier as a pre-amplifier to the receiver with a narrow bandpass filter to block the broadband spontaneous emission from the semiconductor optical amplifier from reaching the photodetectors.
58) The LiDAR system of claim 57 using a single transverse stripe with multi-junctions in the epi-layers to provide greater power and brightness than a single junction where n is the number of junctions and n>1.
59) The LiDAR system of claim 57 using a single transverse stripe with multi-junctions in the epi-layers to provide higher output power than a single junction and where n junctions are used in the primary laser and m junctions are used in the semiconductor optical amplifier with m>1 and n>1.
60) The LiDAR system of claim 57 where the multi-junction laser source can have a wavelength from 1225 nm to 1700 nm.
61) The LiDAR system of claim 57 that uses a polygon scanner to scan the transmitted laser beam and receive the transmitted laser beam producing a 3-dimensional representation of the field of view.
62) The LiDAR system of claim 57 that uses a Risley prism pair to scan the transmitted laser beam and receive the transmitted laser beam producing a 3-dimensional representation of the field of view.
63) The LiDAR system of claim 57 that uses a vibrating mirror to scan the transmitted laser beam and receive the transmitted laser beam producing a 3-dimensional representation of the field of view.
64) The LiDAR system of claim 57 that can be mounted on a rotating platform with either a Risley prism pair, a vibrating mirror or a polygon scanner to provide a 3-dimensional representation of the field of view.
65) The LiDAR system of claim 57 that measures a single point in the field of view.
66) The LiDAR system of claim 57 that can also double as a target designator.
67) The LiDAR system of claim 57 that uses an Avalanche Photo diode as a receiver.
68) The multi-junction laser diode of claim 57 that has a Bragg Grating etched on the top layer to control wavelength over a wide temperature range.
69) The LiDAR system using a multi-junction laser diode of claim 57 that has a Bragg Grating etched on the top layer to control wavelength over a wide temperature range.
70) The LiDAR system using a multi-junction laser diode of claim 57 that uses a multi-junction tapered semiconductor optical amplifier as the high-power laser transmitter.
71) The LiDAR system using a multi-junction laser diode of claim 57 that uses a tapered semiconductor optical amplifier as the high-power laser transmitter and a Bragg Grating stabilized master oscillator integrated on the same chip with feedback isolation trenches.
72) The LiDAR system of claim 57 uses multiple multi-junction laser diodes and multi-junction semiconductor optical amplifiers on a single chip where I is the number of laser diodes and I>1 to increase the output power of the source.
73) The LiDAR system of claim 57 uses multiple individually addressable multi-junction laser diodes and multi-junction semiconductor optical amplifiers on a single chip where I is the number of individually addressable laser diodes and I>1 to provide an electronic beam steering.
74) The LiDAR system using a multi-junction laser diode and multi-junction semiconductor optical amplifier of claim 57 that is integrated into a Silicon Photonic Integrated circuit to provide a complete LiDAR solution on a single chip.
75) The LiDAR system using a multi-junction laser diode of claim 57 that uses a grating in an external cavity in Littrow to narrow and stabilize the wavelength of the laser source over a temperature range and the stabilized output beam is coupled into the multi-junction semiconductor optical amplifier.
76) The LiDAR system of claim 57 that uses a MEMs device to steer the beam over the field of regard.
77) The LiDAR system of claim 57 that is configured as an optical phase array and is electronically steered over the field of view.
78) The LiDAR system of claim 57 that uses a micro-optic, a binary optic, a diffractive optic, a holographic optic, a micro-prism arrangement, or an Axicon to compensate for the displacement of the junctions from the axis of the primary collimating optic to create parallel, collimated output beams.
79) The LiDAR system of claim 57 using a Bragg Grating stabilized laser source and a method to sample the master oscillator beam and mix it with the return beam to enable coherent detection on a double balanced receiver for the time-of-flight pulse.
80) The LiDAR system of claim 57 where a master oscillator is used to injection lock the multi-junction source creating mutually coherent beams from each laser of the multi-junction source.
81) The LiDAR system of claim 57 where the master oscillator, power splitting waveguide and power semiconductor optical amplifier are integrated on the same semiconductor material and the power semiconductor optical amplifier is independently biased from the master oscillator/power splitter section.
82) The LiDAR system of claim 57 where the semiconductor optical amplifiers have low anti-reflection coatings on the input and the output facets.
83) The LiDAR system of claim 57 where the semiconductor optical amplifiers are at an angle to the input and the output facets where the angle is 4°, 5°, or more and the facets have a low anti-reflection coating of 1% or less reflective.
84) The LiDAR system of claim 57 where the semiconductor optical amplifier has a curved waveguide so the master can be injected orthogonal to the back facet while exiting at an angle of 4°, 5°, or more and the facets have a low anti-reflection coating.
85) The LiDAR system of claim 57 where the semiconductor optical amplifier has multiple curved waveguides, where s is the number of curves and s>1, that allow the beam to exit out of any facet including the back facet where the angle is 0°, 4°, 5°, or more and the facets have a low anti-reflection coating of 1% or lower reflectivity.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1a is a schematic diagram showing a Time of Flight scanning LIDAR using multi-junction semiconductor laser transmitter.

FIG. 1b is a schematic diagram showing each mirror on the polygon is tilted slightly with respect to the axis of rotation to create a vertical scan.

FIG. 2 is a schematic diagram showing a Time of Flight scanning LIDAR using multi-junction semiconductor laser transmitter and a single junction semiconductor optical amplifier as preamplifier to detector.

FIG. 3 is a schematic diagram showing a Time of Flight scanning LIDAR using a multi-junction semiconductor laser with a multi-junction semiconductor optical amplifier in the transmitter and single junction semiconductor optical amplifier as preamplifier to detector.

FIG. 4 is a schematic diagram showing a Coherent Time of Flight scanning LIDAR using single-junction pulsed laser as master oscillator injection locking a multi-junction semiconductor optical amplifier and single junction semiconductor optical amplifier as preamplifier to the detector.

FIG. 5 schematically shows a method of injecting a single junction laser diode into a multi-junction laser diode.

FIG. 6 is a schematic diagram showing a Coherent Time of Flight scanning LIDAR using integrated master oscillator, local oscillator, and injection locked semiconductor optical amplifier with single junction semiconductor optical amplifier included in the receive path.

FIG. 7 is a schematic diagram showing a Time of Flight non-scanning LIDAR using multi-junction semiconductor laser transmitter with shared transmit/receive aperture.

FIG. 8 is a schematic diagram showing a Time of Flight non-scanning LIDAR using multi-junction semiconductor laser transmitter and single junction semiconductor optical amplifier as pre-amplifier to the detector.

FIG. 9 is a schematic diagram showing a Time of Flight non-scanning LIDAR using multi-junction semiconductor laser and multi-junction semiconductor optical amplifier transmitter and single junction semiconductor optical amplifier as pre-amplifier to the detector.

FIG. 10 is a schematic diagram showing a Time of Flight LIDAR using multiple individually addressable multi-junction semiconductor lasers for scanning.

FIG. 11 is a schematic diagram showing a Time of Flight LIDAR using multiple individually addressable multi-junction semiconductor lasers with multiple individually addressable multi-junction semiconductor optical amplifiers for scanning.

FIG. 12 is a schematic diagram showing a single junction semiconductor optical amplifier suitable for pre-amplifier. The gain for a picowatt input signal is approximately 30 dB resulting in a nWatt signal to the detector, which is well within the sensitivity range of the detector at 1550 nm.

FIG. 13 is a schematic diagram showing a Semiconductor Optical Amplifier vertical configuration, mode field and transverse confinement.

FIG. 14a is a schematic diagram showing a Triple Junction Semiconductor Device.

FIG. 14b is a schematic diagram showing a Triple Junction Semiconductor Device emission pattern.

FIG. 15 is a plot of power versus current for single, double and triple junction pulsed devices.

FIG. 16 is a schematic diagram showing a Multi-junction high power straight contact semiconductor optical amplifier configurations.

FIG. 17 is a schematic diagram showing a Multi-junction high power tapered contact semiconductor optical amplifier configurations.

FIG. 18 is a schematic diagram showing a Multiple curve waveguide formed by real index guiding rib where the number of curves can be 1 or more even a U shaped curve.

FIG. 19 is a schematic diagram showing a curved rib waveguide launching into a tapered gain guided section.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

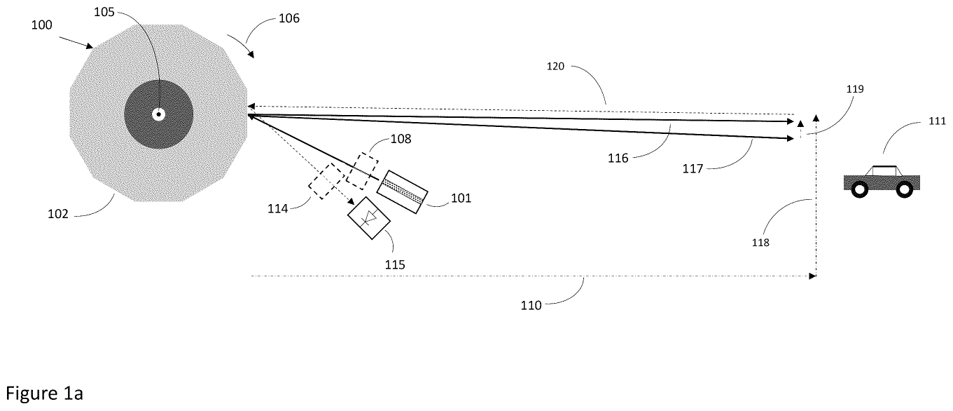

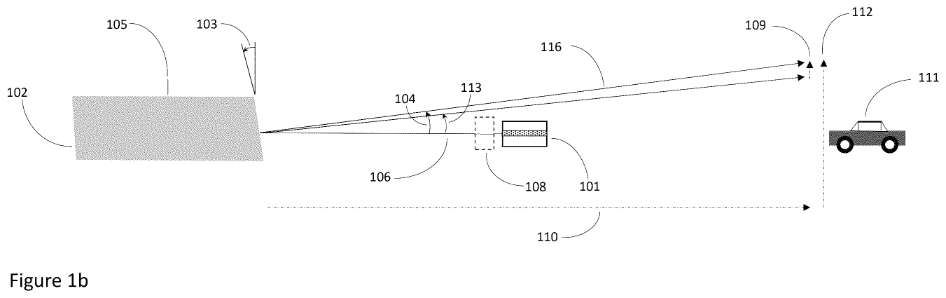

The first embodiment of the time-of-flight LiDAR system is shown in FIG. 1a,1b. A multi-junction laser diode source, (101) is collimated to the appropriate beam diameter such as 5 mm using micro-optics in the fast axis and the slow axis (108). It is possible to also increase this beam diameter with an external telescope that expands the beam or contracts it. The laser pulses are incident on a facet (102) of a rotating polygon mirror (100) that is rotating at a predetermined speed (106) to achieve a complete 3d scan of the field of view in less than 1/10 second, 1/20 second or 1/30 second. Each mirror face (102) of the polygon mirror scans the laser pulses over the horizontal field of view. Each face of the polygon mirror is at a slightly different angle (103) with respect to the polygon's spinning axis (105) The laser beam (106) is perpendicular to the rotating axis (105) of the polygon mirror and incident on the mirror face that is angled (103) with respect to the rotating axis (105) which is then reflected at an angle (104) which is 2× the angle (103) of the mirror face. The angles (103) of each face are chosen to provide a specific vertical scan angle (104, 113) which produces a specific height (112) and resolution (109) at the final range (110) of the LIDAR system. The entire volume of the field of view is scanned once the polygon mirror completes a 360-degree rotation. At that point, the scan begins again. This allows the system to provide a rapidly changing 3-dimensional view of the field of view. The number of vertical scans is determined by the number of faces on the polygon scanner (102). The horizontal resolution (119) is determined by the repetition rate of the laser (101) and the rotational speed (106) of the polygon mirror. The width of the scan (118) is determined by the angular extent of the mirror facet (102) with the beginning of the scan being at the leading edge of the mirror facet (102) and the end of the scan being at trailing edge of the facet (102). The first pulse of light that is transmitted by the laser (101) is the beam path (116), until it encounters an object (111). The scattered beam (120) returns to the polygon mirror (100) which has now moved slightly causing the return beam to be reflected at a different angle than the transmit beam into the receiver (114). The second pulse of light transmitted by the laser (101) creates a second beam path (116) at a slightly different angle than the first beam path. This creates a separation between the first spot on the object (111) and a second spot which is separated from the first spot by a predetermined distance (119) at the range (110) of the LIDAR system. The receiver detector (115) is an avalanche photodiode (APD) which has a high sensitivity (1.5 nW) and its output is monitored by a comparator. When the pulse is first emitted by the laser (101) a timer starts and is stopped when the pulse is detected by the APD (115). The APD gain can be enhanced by using a lens (114) to collect the scattered light from the remote object (111). The time of flight to and from the object is a direct indication of the range of the object (110) from the LiDAR (100) according to the relationship:

Distance=c*Δt/2

Where c is the velocity of light in the medium which for air is 2.99*10¹⁰ m/sec and Δt is the time of flight to and back from the object.

The range capability of the LiDAR system is dependent on several factors: 1) laser (101) peak power (100 Watts) 2) atmospheric transmission losses along path (116,117), 3) the size of the receiver lens (25 mm), and 4) the receiver sensitivity (1.5 nW). An APD produced by Analog Modules (Model 755A-03.1) has a minimum detection level of 1.5 nWatts at 1550 nm. Based on this baseline design, the range capability of a system using a 100 Watt triple junction laser diode from SemiNex and an Analog Modules receiver can be estimated and is shown in Table 2.

Table 1 is calculated using a single junction laser diode which is the industry standard and is based on a minimum detectable power of 1.5 nW. Various target reflectivities and atmospheric conditions are used in this analysis with moderate fog being the most challenging operating condition. I. I. Kim, B. McArthur, and E. Korevarr, “Comparison of laser beam propagation at 785 nm and 1550 nm in fog and haze for optical wireless communications,” Proceedings Vol. 4214, Optical Wireless Communications III; February 2001, doi.org/10.1117/12.417512.

TABLE 1
LiDAR with Single Junction Laser Diode Transmitter

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 320 | 470 | 520 | 280 | 400 | 440 | 90 | 110 | 120 |

Repeating these calculations using a triple-junction laser diode results in a substantial improvement in the range capability of the LiDAR system even in moderate fog.

TABLE 2
LiDAR with Triple Junction Laser Diode Transmitter

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 420 | 630 | 700 | 370 | 510 | 560 | 110 | 130 | 140 |

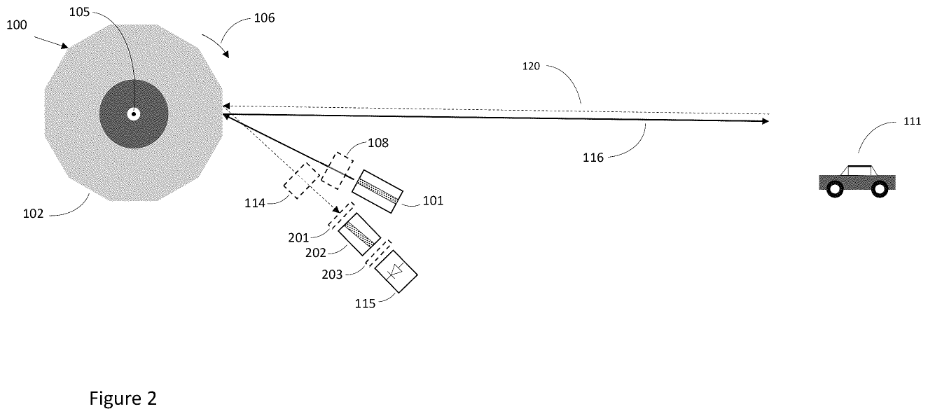

A second embodiment of the invention is shown in FIG. 2. In this embodiment, the high-power pulse is emitted by the multi-junction laser diode (101) which is then collimated by the optics (108) to a given beam diameter such as 5 mm. The laser pulse is reflected into a particular spot in the field of view by the polygon scanning mirror (102) and the field of view is scanned as previously described. If the pulse intersects an object (111) a portion of the pulse is reflected by the object and returned to the receiver lens (114). The receiver lens focuses the return pulse onto the first micro-optic (201) which launches the return pulse into the single junction semiconductor optical amplifier (202). At less than a nW, the semiconductor optical amplifier provides up to 30 dB of small signal gain resulting in a substantial improvement in the minimum detectable power by the APD (115) which can detect signals as low as 1.5 nW. Using the 30 dB small signal gain for the semiconductor optical pre-amplifier the estimated improvement in range is shown in Table 3.

TABLE 3
LiDAR with Triple Junction Laser Diode Transmitter and
Single Junction Semiconductor Optical Pre-Amplifier

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 2,180 | 3,120 | 3,450 | 1,320 | 1,670 | 1,790 | 240 | 270 | 280 |

These two improvements make a substantial improvement in the range capabilities of the LiDAR system, however atmospheric conditions can be even more severe with visibility dropping to 0.05 km in heavy fog. For the LiDAR system to operate with a significant range it is necessary to employ a high-power semiconductor optical amplifier to further boost the output power of the LiDAR transmitter.

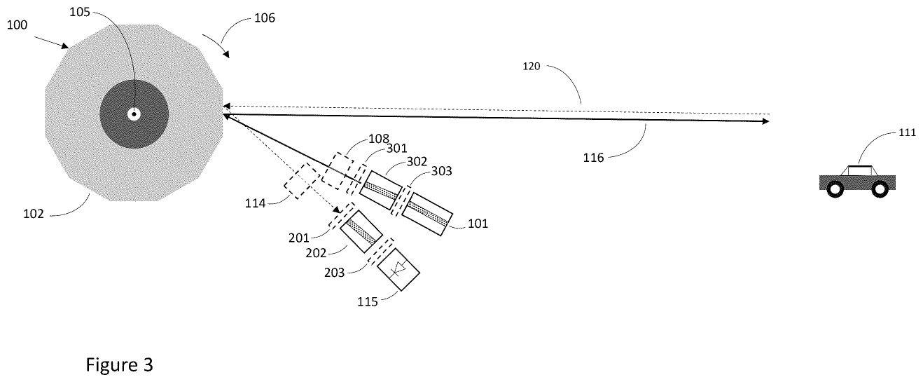

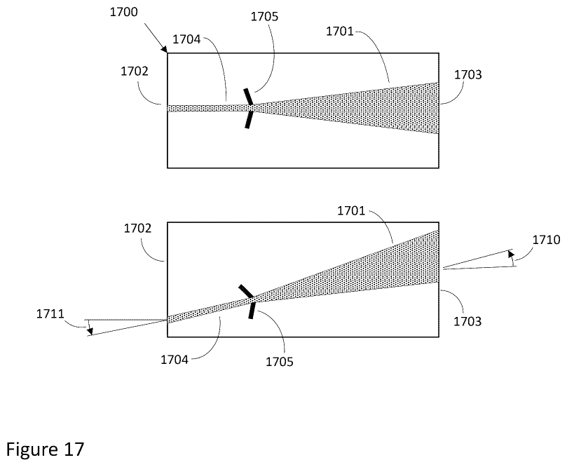

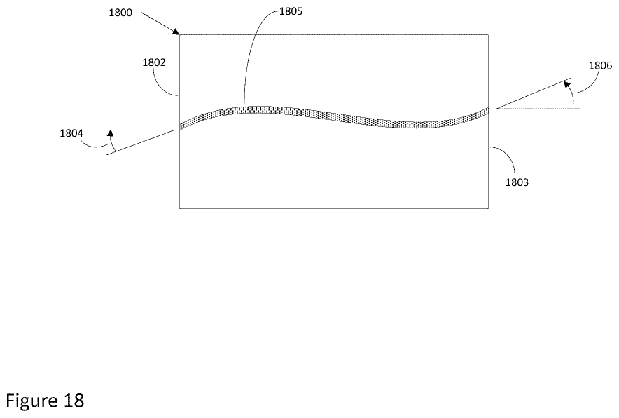

A third embodiment of the invention is shown in FIG. 3 where a high-power multi-junction semiconductor optical amplifier (302) is used to boost the output power of the triple junction laser diode (101). This design also includes the semiconductor optical pre-amplifier (202) described in the previous embodiment. However, during dense fog, back reflections from the fog can confuse the LiDAR system, so it is also necessary to range gate the receiver (115) which is accomplished by turning off the receiver at intervals until a unique return is received which is different from the background scattering off the fog. The laser pulse is first emitted by the laser (301), the micro-optics (303) which are optional are used to launch the laser pulse into the high-power multi-junction semiconductor optical amplifier (302) which can be a wide stripe (1601) or a taper stripe (1701) as shown in FIGS. 17 and 18. The signal injected into the amplifier is then amplified by a factor of 1.5 to 2 or 2 to 2.5 or greater depending on the number of junctions and the width of the semiconductor optical amplifier. Using 200 Watts output power, 1.5 nW detection limit, 30 dB pre-amp gain and active range gating to detect the photons from an object instead of the fog the ranges that can be achieved are shown in Table 4. However, under heavy fog conditions the range gating feature will require the scanning speed to be reduced, so the system will either provide a lower resolution in the field of view or a slower update speed.

TABLE 4
LiDAR with High Power Semiconductor Optical Amplifier
and Single Junction Semiconductor Optical Pre-Amplifier

| | CLEAR | | | Haze | | | Heavy Fog 0.05 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 2,550 | 3,620 | 4,010 | 1,460 | 1,840 | 1,960 | 80 | 90 | 90 |

Table 4 highlights the difficulties with using a time-of-flight LiDAR system in a heavy fog environment because of the backscatter and severe attenuation of the beam. While this is tremendous improvement over Table 1, there is still a need to achieve at least a 200 m detection range through the heavy fog. Here multiple laser sources can be used, however with a scanning system this implementation becomes more difficult because of the need to use a larger transmit aperture which results in a larger polygon scanning mirror as well as greater cost.

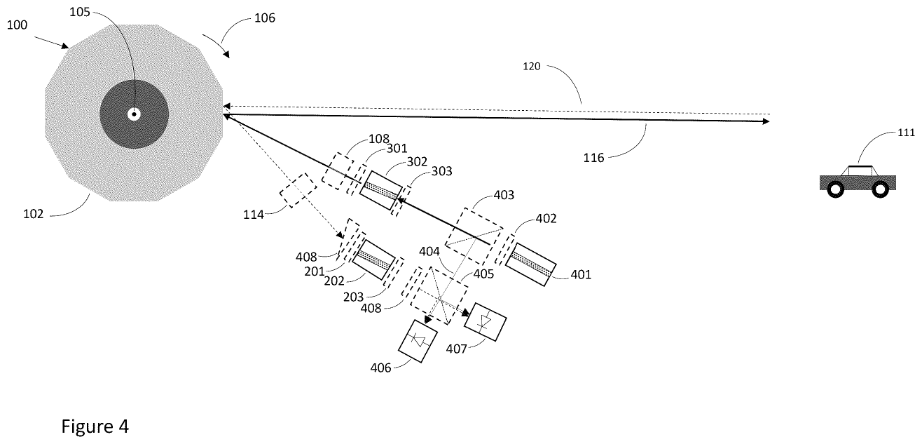

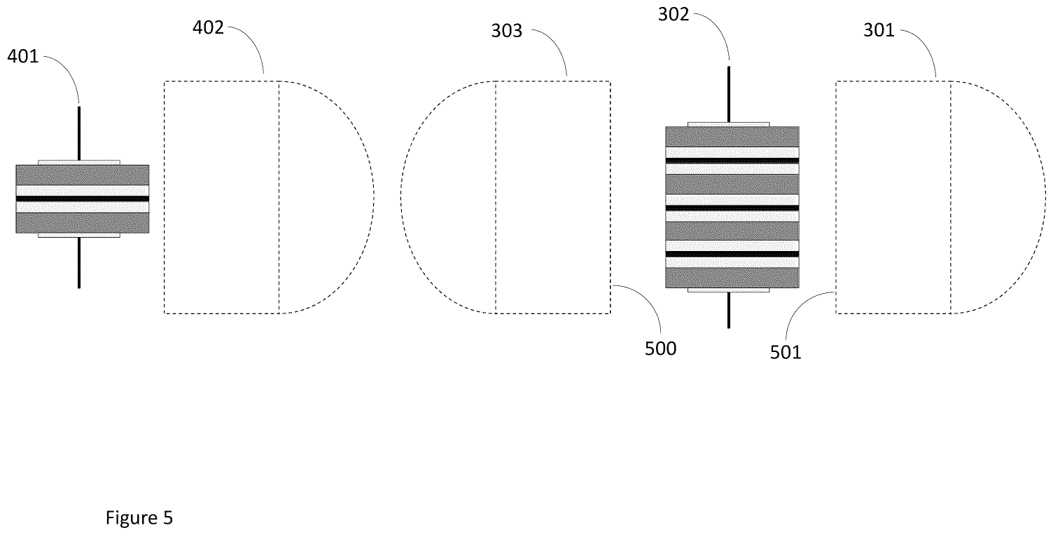

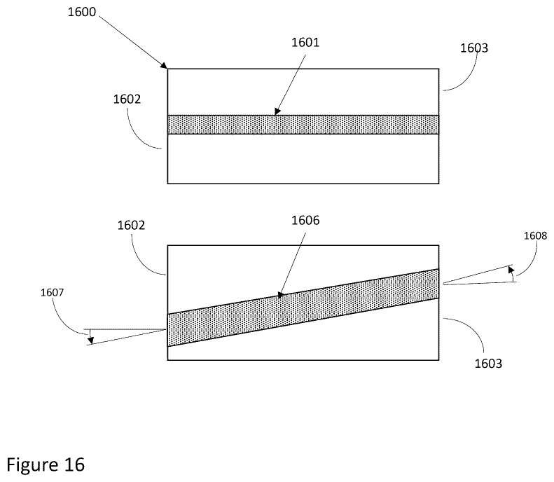

A fourth embodiment of the invention is shown in FIG. 4 which uses coherent detection of the return pulse to greatly improve the performance of the system. The single junction master oscillator (401) output is collimated by the micro-optic (402). The beam passes through a beam splitter (403) where depending on the master oscillator power and the power required by the receiver the beam power may be split 90:10, 99:1, 99.9:0.1 or 99.99:0.01 where the higher power level is used to inject the multi-junction semiconductor optical amplifier and the sampled power is transmitted to the receiver (404). The high output power is achieved by coupling the output from the single junction laser diode (401) into the multi-junction semiconductor optical amplifier (302). In FIG. 5 the micro-optic (402) collimates the output of the single junction laser diode (401). A separate micro-optic (303) reimages the master oscillator mode to fill all three junctions. This may also be a more complex optical element (500) incorporating a diffractive beam splitter or a holographic optical beam splitter which splits the master oscillator mode into three equal modes and injects all three junctions simultaneously (302). The output optic can be either a simple lens (301) or a more complex lens element with prisms (501) on the back side of the lens to compensate for the off-axis position of the upper and lower junctions which increases the output brightness compared to a simple lens solution (301). The beam pointing correction (501) may be accomplished with a micro-prism array, an axicon, a diffractive element or a holographic element. The output beam now consists of three in phase beamlets that can be coherently detected. The output of the multi-junction semiconductor optical amplifier (302) which may be of the designs illustrated in FIGS. 16 and 17, may be further shaped to provide the appropriate beam diameter by the optical element (108). The optical element (108) may be single lens, a telescope, an anamorphic prism pair, a beam shaper or other means to create the appropriate far-field pattern on the target (111). The beam is scanned in the far-field by a polygon scanning mirror (100) to interrogate the vertical and horizontal field of view. The return beam (120) reflects off of the polygon scanning mirror (102) which has now moved from its original position. The new position causes a slight angular separation between the transmitter and the receiver. The receiver optic (114) collects the return beam and shapes it to launch it through the semiconductor optical amplifier (202) and then into the photo-diode receiver (406,407). One skilled in the art will recognize that the receiver can be a separate receiver aperture and does not have to use the polygon scanning mirror to collect the return beam. However, this configuration provides the smallest package and the lowest cost. The received beam passes through a prism (408) to correct the angle of incidence into the receiver. The angle of incidence is very important for a coherent detection system to make certain there is only one fringe being modulated across the photo-diode detectors (406,407). The amplified beam is collimated by micro-optics (203) as it leaves the semiconductor optical amplifier and then passes through a 50:50 beam splitter to be combined with the sampled master oscillator (404) power or local oscillator. Prior to reaching the photodiodes (406, 407) a narrow bandpass filter (408) is inserted in the path to block the broadband amplified spontaneous emission from the semiconductor optical amplifier (202) in the receiver as well as the light leakage from the amplified spontaneous emission from the power semiconductor optical amplifier (302) in the transmit path. It should be noted that the photo-diode receiver (406,407) is a double balanced configuration which is well known to those skilled in the art.

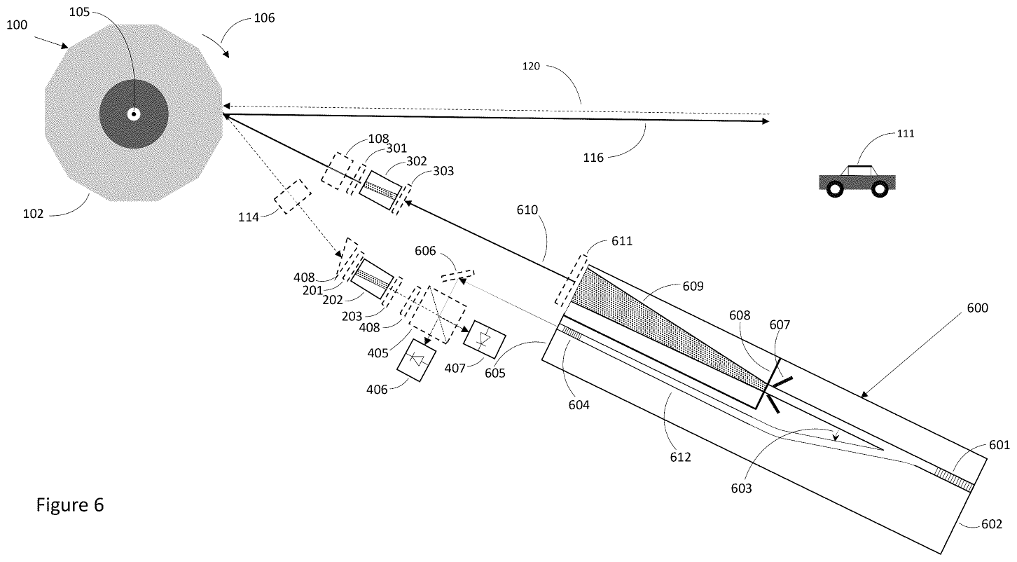

FIG. 6 shows a fifth embodiment of the invention using an integrated master oscillator which greatly simplifies the design of the transmitter and the receiver. The master oscillator consists of two mirrors and an amplifier section. The back mirror may be either the rear facet (602) or a Bragg grating reflector (601). The front mirror may be either an AR coated front facet (605), a specific coating on the front facet, or a Bragg Grating reflector (604) with an AR coated front facet (605). One skilled in the art will also recognize that the Bragg Grating reflector could be a weak reflector along the entire length (612) of the master oscillator. The integrated chip (600) includes a waveguide at a predetermined angle (603) which samples the master oscillator forward traveling wave in the oscillator section. The amount of power sampled is determined by the angle (603) between the master oscillator and the waveguide branching off. The power sampling ratio could be 1%, 10%, or even 50%, again depending on the angle (603). The power semiconductor optical amplifier section (609) is electrically isolated from the master oscillator section by the deep trench (608) through the p-cap region which allows each section to be independently biased. An additional set of deep trenches (607) are etched adjacent to the branching waveguide to diffract the beam into the tapered semiconductor optical amplifier (609). The semiconductor optical amplifier can be of any design depending on the output power requirements, it can be the tapered version shown in this figure, a straight waveguide, a curved waveguide or an angled waveguide. The output of the tapered section in this preferred embodiment is set at an angle of 4 degrees from the normal to the facet. While any angle can be used including perpendicular to the facet, this angle or greater is preferred. The output of the tapered section is now collimated by the micro-optic (611) and reshaped (303) to inject into a multi-junction semiconductor optical amplifier (302). In the preferred embodiment the master oscillator is operated CW to keep its frequency stable and the linewidth sufficiently narrow that it has a coherence length that greatly exceeds the maximum range anticipated. The output pulse is created by modulating either the integrated semiconductor optical amplifier (609) or the multi-junction semiconductor optical amplifier (302). One skilled in the art will recognize that if sufficient power is generated in the tapered semiconductor optical amplifier section (609), then the multi-junction semiconductor optical amplifier section would not be needed, it all depends on the range and operating conditions the system is being designed to operate in. Since the master oscillator is operating CW, the local oscillator signal is present when the return signal is received. The output beam is shaped by an optical element (108) and transmitted to the target after reflecting from the polygon scanning mirror (100). The return beam (120) is reflected off the polygon scanning mirror which has now moved slightly creating a different angle for the return beam and providing a physical separation of the transmitter and the receiver. The receiver optical element (114) launches the beam into the receiver where it passes through a prism (408) to correct any angular deviation. A set of micro-optics (201) condition the beam and launch it into the semiconductor optical amplifier (202) the output of which is collimated by an optical element (203). The beam passes through a narrow band filter (408) to block the broadband Amplified Spontaneous Emissions (ASE) from the semiconductor optical amplifier (202). The filtered received beam is then mixed with the local oscillator beam in a 50:50 beam splitter cube (405). The two resulting beams that are 90 degrees out of phase are then transmitted to two photodiodes (406,407) which make up a double balanced detector.

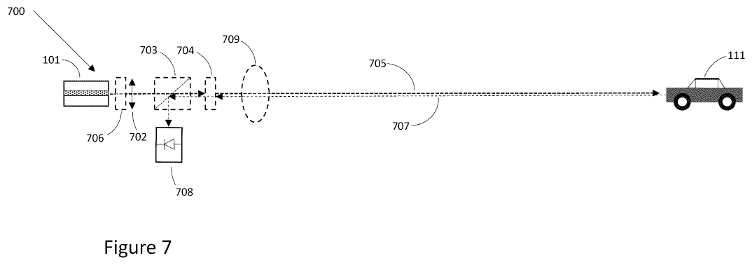

A sixth embodiment of the invention is shown in FIG. 7, which is a non-scanning LiDAR system which can use a larger transmit/receive aperture which greatly improves the performance of the range finding system. The multi-junction laser (701) is pulsed at a 10 nsec or less pulse width, the output beam is collimated by micro-optics (706) and is p-polarized (702) when incident on the polarization beam splitting cube (703). The beam is then converted to circular polarization by the ¼ waveplate (704). A 25 mm transmit aperture (709) is used to transmit the right circular polarized beam (705) to the target (111). The reflected beam is left circular polarized (707) and sampled by the transmit/receive optic (709). The waveplate (704) converts the left circular polarized light to s-polarized light with respect to the polarization beam splitter (703) and the received beam is reflected onto the APD (708) with minimal losses in the optical system. Table 5 shows the Laser Rangefinder performance with a single junction laser diode and Table 6 shows the result for the triple junction laser diode (701) at 100 Watts peak power. This system may also use the coherent detection outlined in FIG. 4-6 for additional range enhancement.

TABLE 5
Laser Rangefinder with Single Junction Laser Diode Transmitter

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 350 | 760 | 940 | 280 | 510 | 600 | 80 | 110 | 120 |

The ranges achieved for the laser rangefinder application exceed those of the scanned LiDAR (Table 2) because of the larger diameter transmission lens (709).

TABLE 6
Laser Rangefinder with Triple Junction Laser Diode Transmitter

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 680 | 1,350 | 1,510 | 470 | 790 | 900 | 110 | 130 | 140 |

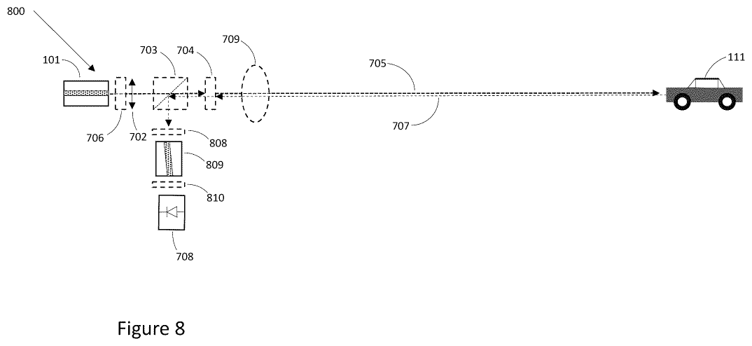

A seventh embodiment of the invention is shown in FIG. 8, which is a non-scanning LiDAR system which can use a larger transmit/receive aperture which greatly improves the performance of the range finding system. The multi-junction laser (101) is pulsed at a 10 nsec or less pulse width, the output beam is p-polarized (706) incident on the polarization beam splitting cube (703). The beam is then converted to circular polarization by the ¼ waveplate (704). A 25 mm transmit aperture (709) is used to transmit the right circular polarized beam (705) to the target (111). The reflected beam is left circular polarized (707) and sampled by the transmit/receive optic (709). The waveplate (704) converts the left circular polarized light to s-polarized light at the polarization beam splitter (703) which is reflected in the PBS cube and the received beam is coupled into the single junction semiconductor optical amplifier (809) by the micro-optic (808), recollimated by a micro-optic (810) and then coupled into the APD (708). This amplifier (809) provides the system with an additional 30 dB of small signal gain. Table 7 shows the Laser Rangefinder performance of the triple junction laser diode (101) at 100 Watts peak power with the 30 dB receiver semiconductor optical pre-amplifier (808,809,810). This system may also use the coherent detection outlined in FIG. 4-6 for additional range enhancement.

TABLE 7
Laser Rangefinder with Triple Junction Laser Diode Transmitter and Pre-Amplifier

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 4,400 | 6,080 | 6,660 | 2,080 | 2,520 | 2,660 | 240 | 270 | 280 |

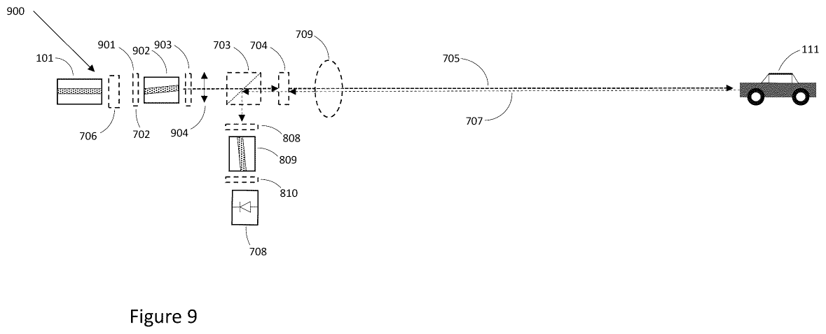

An eighth embodiment of the invention is shown in FIG. 9, which is a non-scanning LiDAR system which can use a larger transmit/receive aperture which greatly improves the performance of the range finding system. The multi-junction laser (101) is pulsed at a 10 nsec or less pulse width which is coupled into a high-power semiconductor optical amplifier (902) through the micro-optic assembly (706, 901), the output beam is collimated by the micro-optics (903) and is p-polarized (904) incident on the polarization beam splitting cube (703). The beam is then converted to circular polarization by the ¼ waveplate (704). A 25 mm transmit aperture (709) is used to transmit the right circular polarized beam (705) to the target (111). The reflected beam is left circular polarized (707) and sampled by the transmit/receive optic (709). The waveplate (704) converts the left circular polarized light to s-polarized light at the polarization beam splitter (703) and the reflected received beam is coupled into the single junction semiconductor optical amplifier (809) through the micro-optic (808) and coupled into the APD (708) through the micro-optic (810). This provides the system with an additional 30 dB of small signal gain. Table 8 shows the Laser Rangefinder performance of the amplified (902) triple junction laser diode (101) at 100 Watts peak power with the 30 dB receiver pre-amplifier (808,809,810). This system may also use the coherent detection outlined in FIG. 4-6 for additional range enhancement.

TABLE 8
Laser Rangefinder with Amplified Triple Junction Laser Diode
Transmitter and Semiconductor Optical Pre-Amplifier

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 5,070 | 6,950 | 7,590 | 2,260 | 2,730 | 2,870 | 250 | 290 | 300 |

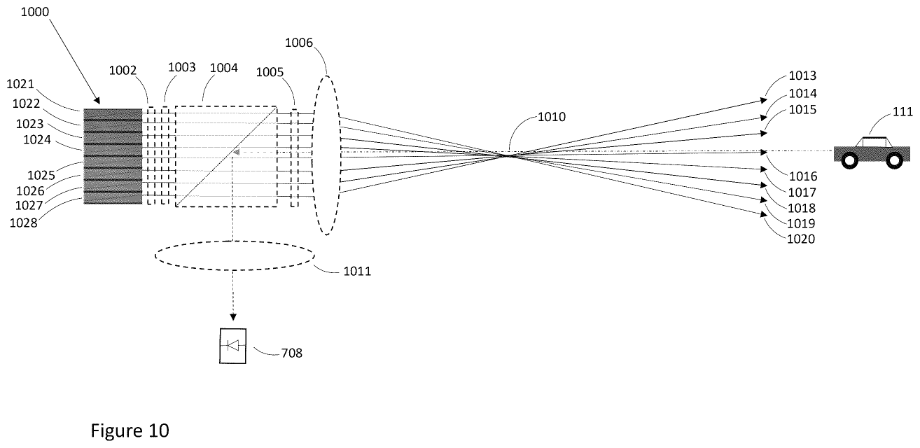

A ninth embodiment of the invention is shown in FIG. 10, which is a means to add electronic scanning to a laser rangefinder and make it a low-resolution LiDAR system. An array of individually addressable multi-junction laser diodes (1000) where each emitter is individually collimated by a micro-optic in the fast axis (1002) and the slow axis (1003) or may use a Beam Transformation System as micro-optic (1002) and a larger optic (1003) to create a lower divergence beam. This array of beamlets is p-polarized and incident on the polarization beam splitting cube (1004). A ¼ waveplate (1005) is then used to convert the p-polarized light to right circularly polarized light. By turning each individual emitter on and off a different zone of the field of view can be searched for a return. For example, turning on emitter 1021 illuminates a zone depicted by ray 1020. Turning on emitter 1022 illuminates a zone depicted by ray 1019. Emitter 1023 illuminates zone 1018. Emitter 1024 illuminates 1017. Emitter 1025 illuminates 1016 which provides the return beam 1010 and consequently a positive range measurement for an object in this space. Emitter 1026 illuminates zone 1015. Emitter 1027 illuminates zone 1014 and finally, emitter 1028 illuminates zone 1013. This approach can be extended to two dimensions by stacking these arrays with individual addressability to every emitter. The return ray (1010) is left circular polarization and is collected by the transmission/receiver optic (1006). The waveplate (1005) converts the left circular polarized light to s-polarized light which is then reflected by the polarization beam splitter (1004) to the receiver optic (1011) and the APD receiver (708). The ray images are scaled such that they just fill the receiver aperture regardless of which emitter was addressed to transmit a beam to the field of view. The two limitations of this approach are the finite size of the collimated beams (1 mm) set by the separation of the emitters and the limitation on the size of the optics (1006) to be used which determines the cost of the system. This system can generate 2-D or 3-D images depending on whether a linear array or 2-dimensional array of emitters is used in the system.

TABLE 9
Performance with Electronically Scannable Laser
based on Triple Junction Laser Diode Transmitters

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 190 | 290 | 320 | 180 | 260 | 290 | 90 | 110 | 110 |

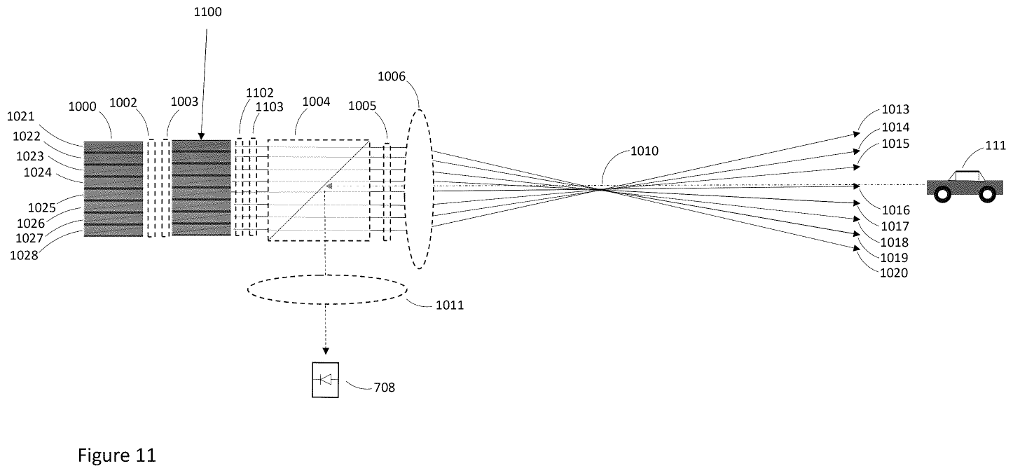

A tenth embodiment of the invention is shown in FIG. 11, which includes a means to increase the output power of the individually addressable elements by using a multi-junction broad stripe semiconductor optical amplifier section. An array of individually addressable multi-junction laser diodes (1000) where each emitter is individually coupled by a micro-optic (1002, 1003) into each of the high-power semiconductor optical amplifiers (1100). Each of the high-power semiconductor optical amplifier emitters are then collimated using micro-optics (1102) for the fast axis and (1103) for the slow axis. The high-power triple junction emitters (1000) can also be fabricated on the same wafer as the high-power semiconductor optical amplifier section (1100) where the high-power semiconductor optical amplifiers are the designs shown in FIG. 16 (1601, 1606) or FIG. 17 (1701, 1708). This array of beamlets is p-polarized and incident on the polarization beam splitting cube (1004). A ¼ waveplate (1005) is then used to convert the p-polarized light to right circularly polarized light. By turning each individual emitter on and off a different zone of the field of view can be searched for a return. For example, turning on emitter 1021 illuminates a zone depicted by ray 1020. Turning on emitter 1022 illuminates a zone depicted by ray 1019. Emitter 1023 illuminates zone 1018. Emitter 1024 illuminates 1017. Emitter 1025 illuminates 1016 which provides the return beam 1010 and consequently a positive range measurement for an object in this space. Emitter 1026 illuminates zone 1015. Emitter 1027 illuminates zone 1014 and finally, emitter 1028 illuminates zone 1013. This approach can be extended to two dimensions by stacking these arrays with individual addressability to every emitter. The return ray (1010) is left circular polarization and is collected by the transmission/receiver optic. The waveplate converts the left circular polarized light to s-polarized light which is then reflected by the polarization beam splitter (1004) to the receiver optic (1011) and the APD receiver (780). The system may be modulated on/off by either modulating the primary oscillators (1000) while the amplifiers (1100) operate continuously, or by the primary oscillators (1000) running continuously and modulating the amplifiers (1100). The last mode is to synchronously modulate the primary oscillators (1000) and the power amplifiers (1100). The ray images are scaled such that they just fill the receiver aperture regardless of which emitter was addressed to transmit a beam to the field of view. This system can now provide additional range assuming a pulse output power of 200 Watts from a single broad stripe emitter and with a 1 mm diameter beamlet for each emitter. The performance of this system is shown in Table 10.

TABLE 10
Performance with Triple Junction Laser Diodes
with Broad Stripe Triple Junction Amplifiers

| | CLEAR | | | Haze | | | Moderate Fog 0.2 km visibility | | |
|---|---|---|---|---|---|---|---|---|---|
| | 10 cm target | | | 10 cm target | | | 10 cm target | | |
| Target Reflectivity | 10% | 50% | 80% | 10% | 50% | 80% | 10% | 50% | 80% |
| RANGE (m) | 230 | 340 | 380 | 210 | 300 | 330 | 100 | 120 | 120 |

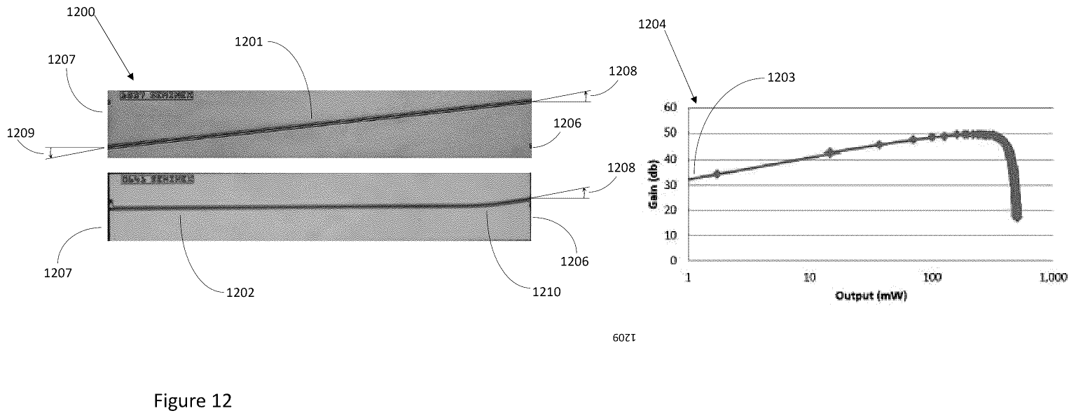

A key element of the invention is the semiconductor optical pre-amplifiers shown in FIG. 9. These semiconductor optical pre-amplifiers have a single pn junction and waveguide and provide up to 30 dB of small signal gain at 1550 nm (1204), or up to 500 mW of output power (1203) when operated in the fully saturated mode. This figure shows two configurations, an angled straight waveguide section (1201) with low reflectivity coatings (0.01%) on each facet (1206,1207), and a straight waveguide section (1202) with a curve section (1210) toward the end of the waveguide which results in an angle (1208) at the output facet that also has low reflectivity coatings on each facet (1206,1207). Both of these designs are based on a 4 μm waveguide that is 2500 μm long. The mode field is approximately 2.7 μm in the fast axis and 5.2 μm in the slow axis. The waveguide is an index guide created by a 4 μm wide step on the p-cap layer to create the lateral confinement structure. The first design is the angled waveguide with the angle at 4 degrees from normal to the output (1208) or input facets (1209), or higher. This angled design (1201) completely suppresses any parasitic oscillations which would manifest as noise in the final system when combined with a low AR coating on the both facets. Similarly, the second design (1202) achieves the same result, but now with a straight section (1202) at launch a curve (1210) an angle at the output facet (1208). This design makes launching into the waveguide much easier given the normal incidence that can be used from the preceding component or optical system. Both devices provide the same performance. The calculations provided for embodiments 2, 3, 5 and 7 all assume that the optical signal can be easily coupled into the waveguide structure and that as a pre-amplifier it provides the 30 dB of measured small signal gain (1203) shown in FIG. 12.

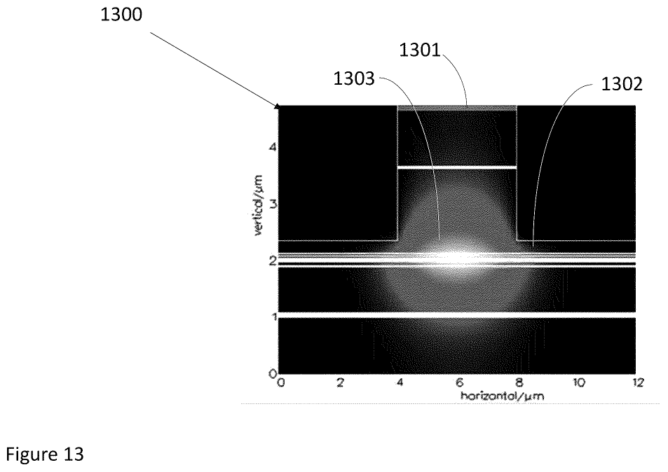

FIG. 13 shows the transverse structure (1300) of the single junction semiconductor optical amplifier. The rib waveguide that is 4 μm wide (1301) confines the mode laterally and the epi layers (1302) confine the single mode in the transverse direction.

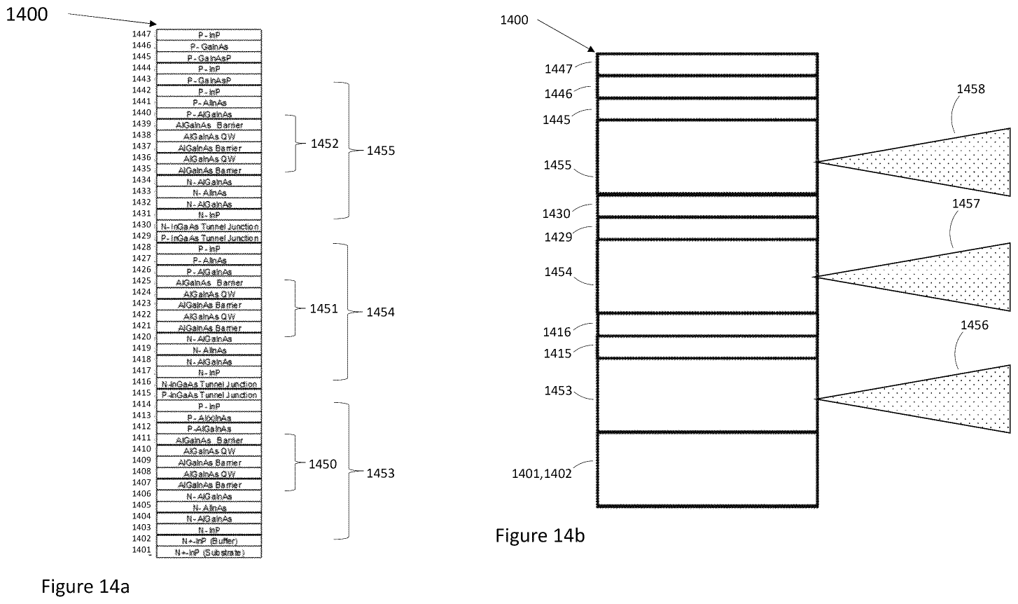

A twelfth embodiment of the invention is shown in FIG. 14a. FIG. 14a shows the epitaxial layer structure for a multiple (triple) monolithic laser diode structure 1400 which has been constructed according to the principles of the present invention. The side view shown in FIG. 14b shows how each laser diode (1453,1454,1455) of the monolithic laser diode structure produces its own beam, Beam 1456, Beam 1457, Beam 1458.

In more detail, three monolithic laser diodes (1450,1451,1452) are stacked, epitaxially together in the illustrated embodiment. However, in other examples, two or more than three laser diodes are stacked.

The thickness of multiple monolithic laser diode structure (1400) is slightly thicker than a single laser diode structure. In addition, the voltage drop in a multiple monolithic laser diode structure (1400) is higher than a single laser diode by more than 10 times in some cases. Specifically, the voltage drop is more than two times the single diode voltage for the double monolithic laser diode structure. The voltage drop is more than three times the single laser voltage for the triple monolithic laser diode structure.

In addition, the temperature in the active areas (1450,1451,1452) of the respective laser diodes (1453,1454,1455) of the multiple monolithic laser diode structure (1400) is higher compared to the active area of a single laser diode because of the higher voltage and higher thickness. In general, stacking epitaxially multiple laser diodes is an issue due to high voltage and thickness, which increases optical and electrical losses causing the laser to heat up, reduce optical performance, and reduce reliability.

In the illustrated example, the monolithic laser diodes (1453,1454,1455) are connected one to another by respective tunnel junctions. Each tunnel junction is formed from an n-type InGaAs layer and a p-type InGaAs layer. Specifically, a first tunnel junction is located between the bottom laser diode (1453) and the subsequent monolithic laser diode (1454) and comprises a p-type InGaAs layer (1415) and a n-type InGaAs layer (1416). A second tunnel junction is located between the middle laser diode (1454) and the top monolithic laser diode (1455) and comprises an p-type InGaAs layer 1429 and a n-type InGaAs layer 1430.

If higher power is required, the monolithic laser diode structure (1400) can have a greater number of laser diodes, more than three.

As illustrated in FIG. 14a, each monolithic laser diode contains an active area (1450,1451,1452). The active area (1450) of the first laser diode (1453) comprises a first AlGaInAs barrier layer (1407), a first AlGaInAs quantum well (1408), a middle AlGaInAs barrier (1409), a second AlGaInAs quantum well (14010), and a second AlGaInAs barrier (1411). In a similar vein, the active area (1451) of the second laser diode (1454) comprises a first AlGaInAs barrier layer (1421), a first AlGaInAs quantum well (1422), a middle AlGaInAs barrier (1423), an AlGaInAs quantum well (1424), and a second AlGaInAs barrier (1425). Finally, the active area (1452) of the third laser diode (1455) comprises a first AlGaInAs barrier layer (1435), a first AlGaInAs quantum well (1436), a middle AlGaInAs barrier (1437), a second AlGaInAs quantum well (1438), and a second AlGaInAs barrier (1439).

The active areas (1450,1451,1452) are located between waveguide layers and inner and outer cladding layers. In general, the inner cladding layers have smaller thickness than the outer cladding layers.

In addition, the active areas (1450,1451,1452) of the laser diodes (1453,1454,1455) will contain a single or multiple quantum well structure. Quantum well material composition and layer thicknesses are currently selected based on the desired semiconductor laser emission wavelength between 1300 nm and 1700 nm.

In many embodiments, it is important that the laser diodes (1453,1454,1455) emit at the same wavelength. Many applications need center wavelength emission of the multiple laser to be within 10 nm of each other during operation, and preferably within 5 nm during operation and ideally within 1 nm or less.

The emission wavelengths can be measured by operating the multiple monolithic laser diode (1400) at room temperature of some heating or cooling of the laser and measuring the emission wavelength. An alternative way to measure wavelength is to measure by photoluminescence emission which is done at the epitaxial wafer level or measurement of a laser diode emitter preferably with the metallization removed. To achieve wavelengths that operate at these closely space or the same wavelengths is difficult because each monolithic laser diode (1453,1454,1455) will naturally operate at a different temperature due to how deep it is in the structure (1400) and how much heating is transmitted by neighboring lasers. In other words, deeper emitters are farther from the cooling side of the structure and run hotter. In addition, emitters sandwiched between other emitters are heated by their neighboring emitters and run much hotter.

In general, heating of laser diodes (1453,1454,1455) shifts the operating wavelength higher, and thus if each laser diode (1453,1454,1455) is running at a different temperature, then they will shift differently to higher temperatures.

To achieve close operating wavelengths for each of multiple laser diode (1453,1454,1455) in the common semiconductor, the composition and thicknesses of each laser diode (1453,1454,1455) should be different enough to compensate for the wavelength shift due to heat. The cold, or unheated, wavelength of each emitter can be measured using photoluminescence (PL) measurements where the wavelength is measured without inducing heat into the emitter. To compensate for the operating the PL measurement of emitters can differ by as little at 1 nm and as much as 10 nm.

In addition, the p-doping is zinc in a current embodiment. Zinc diffusion in the active areas of one, two or three monolithic active areas shift the wavelength to higher values and this is measured at photoluminescence, In order to have all 2 or 3 monolithic lasers emitting at the same wavelength, it is required to compensate for the wavelength by changing the thickness and/or material composition of the active areas.

Specifically, the quantum well thickness and quantum well material composition differ from one monolithic laser to another in the multiple monolithic laser diodes (1453,1454,1455) to achieve different emission wavelengths. In some embodiments, it is preferable to have different emission wavelengths of 5 nm or greater between the different monolithic diodes. In some other embodiments, itis preferable to have emission wavelengths close together or the same within 5 nm or less between the different monolithic diodes.

The wavelength emissions difference between active areas (1450,1451,1452) caused by different temperatures of the active areas (1450,1451,1452) of the monolithic laser diodes (1453,1454,1455) are reduced by material composition compensation.

The composition and thickness of quantum wells is adjusted so the emission is at the same wavelength or at different wavelength from one active area to another one of the active areas (1450,1451,1452). This could be measured using X-ray diffraction characterization at epitaxial wafer level.

In addition, n-doped indium phosphide substrate layer n+ InP is an electrically conductive InP substrate. A p type GaInAs layer (1445) is grown at the end of the epitaxial layers growth to make the P-ohmic contact layer.

The first layer (1401) grown on the substrate is follows by a n+ InP buffer layer (1402), which is used to grow the epitaxial growth of the multiple monolithic laser diode (1400) including the monolithic laser diodes (1453,1454,1455). The buffer layer thickness is approximately 1 micron.

Each multiple monolithic laser active areas (1450,1451,1452) is positioned within the center of an optical confinement layer of either the step index type or the graded index type separate confinement heterostructure (GRIN-SCH). An InP layer on each side of each active area (1450,1451,1452) forms the optical cladding layer for the optical confinement structure and the multi-quantum well (MQW) active layers. Lateral optical confinement is provided for by either a buried heterostructure or a ridge waveguide structure.

The device is operated by a vertical current injection type. Lateral current confinement is achieved by either buried stripe geometry, or a ridge waveguide of raised ridge or dual trench formation, an alternative combination is implant isolation, or mesa isolation, whereby oxide depositions confine the current to the central region of the lateral optical confinement structure.

Here, the general objective is to provide a monolithic semiconductor laser diode structure emitting multiple beams in long wavelength range (1300 nm-1700 nm). The multiple monolithic laser diodes are connected with tunnel junctions. The multiple monolithic laser layers and tunnel junction layers are designed in a way to reduce the stress and to improve the heat dissipation generated by each laser diode and each active area. Temperature variation reduction between multiple active areas, reduce the wavelength differences between the multiple monolithic laser diodes active areas.

It is recommended for the tunnel junctions (1415, 1416), (1429,1430) to be thin in order to reduce absorption and losses. The thickness of the tunnel junctions can be 50 nm or less.

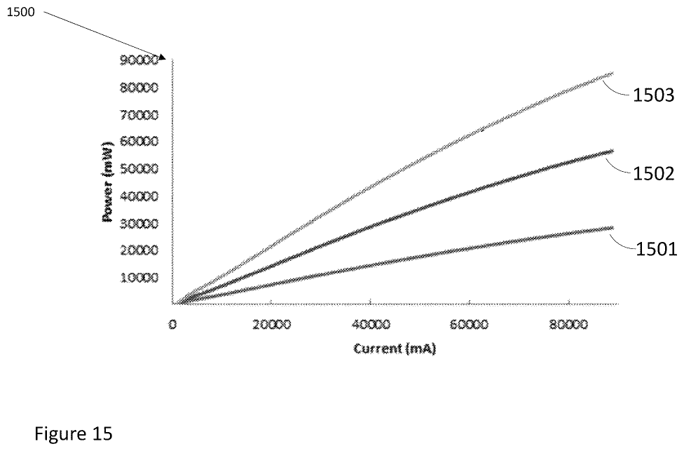

The multiple monolithic semiconductor laser structure using aluminum indium gallium arsenide (AlInGaAs), gallium indium arsenide phosphide (GainAsP), indium gallium arsenide (InGaAs), indium phosphide (InP), (AlGaInAs/GaInAsP/InGaAs/InP) material system. Each monolithic laser design, the active area layers, the design of the optical cavity and the design of tunnel junction are preferably optimized to minimize the temperature increase of the active area and to minimize the effects on the laser efficiency. The result is a high output power semiconductor laser for the wavelengths between 1300 nm and 1700 nm, as shown in FIG. 15. The output power of single laser is high (1501); the output power of double monolithic laser is almost double of single laser power (1502). The output power of triple monolithic laser diode is almost triple of single laser power (1503). The same power increase is expected for four or more monolithic laser diode for short pulse operation.

The multiple monolithic semiconductor laser structure of FIG. 14a containing multiple monolithic diodes (1453,1454,1455), each laser diode containing an active area (1450,1451,1452). The active areas (1450,1451,1452) are epitaxially grown between waveguide layers (1406, 1412, 1420, 1426, 1434, and 1440). The waveguide layers (1406, 1412, 1420, 1426, 1434, and 1440) are surrounded by cladding layers (1403, 1404, 1414, 1417, 1418, 1428, 1431, 1432, 1442). The cladding layers are epitaxially grown above and below the waveguide layers and the active areas. Each monolithic laser diode is connected to the subsequent monolithic laser by a tunnel junction (1415, 1416) and (1429, 1430).

In this structure, the active area of each monolithic laser diode (1450,1451,1452) is a strain compensated multi-quantum well structure containing a compressive strained AlGaInAs wells (1408, 1410, 1422, 1424, 1436,1438) and tensile strained AlGaInAs barrier layers (1407, 1409, 1411, 1421, 1423, 1425, 1435, 1437, 1439). The thickness of the quantum well is 10 nanometers or less. The width of the well is adjusted to achieve the desired operating wavelength without exceeding the critical thickness.

Each active area of multiple monolithic laser diodes is positioned within the center of an optical confinement layer of either the step index type or the graded index type separate confinement heterostructure (GRINSCH). An InP layer on each side (1403, 1414), (1417, 1428), (1431, 1442) forms the optical cladding layers for the optical confinement structures of each monolithic laser diode (1453,1454,1455) and the multi-quantum well (MQW) active (1450,1451,1452). Lateral optical confinement is provided by either a buried heterostructure or a ridge waveguide structure.

The multiple laser diode active areas (1450,1451,1452) contain one, two, three or more quantum AIInGaAs wells surrounded by AlInGaAs barriers. The active areas are centered in P-type and N-type AlInAs/AIInGaAs/InP waveguide. The waveguide layers (1406, 1412), (1420, 1426) and (1434, 1440) are surrounded by AlGaInAs/InP cladding layers (1403, 1414), (1418, 1428), (1431, 1442). Each monolithic laser diode (1453,1454,1455) is connected to the next monolithic laser by a tunnel junction InGaAs/InGaAs (1415, 1416) and (1429, 1430).

FIG. 14a shows the layer structure of a multiple semiconductor laser used to construct multiple monolithic laser devices as per the present embodiment. The epitaxial structure shown in FIG. 14a is using conventional III-V compound semiconductor epitaxial growth techniques such as metal organic chemical vapor deposition (MOCVD) and molecular beam epitaxy (MBE).

The preferred structure is as follows. The starting substrate (1401) is N+-type InP, followed by a 1 micron N+ type InP buffer layer, on to which a 1 micron thick N+ InP lower cladding layer with a silicon (Si) doping concentration of 3e¹⁸ cm⁻³ maximum is grown followed by a transition region 15 nm thick of lattice matched, graded (AlxGa₍₁₋ₓ₎₎In_{0.53}As (where 0.5<x<1) to Al_{0.48}In_{0.52}As (1404-1405) into the separate confinement heterostructure (SCH) layers (1405-1413). Next is the lower graded-index (GRIN) layer (1406), which is 45 nm thick beginning with Al_{0.48n}In_{0.52}As and ending with (AlxGa₍₁₋ₓ₎In_{0.53}As (where 0.5<x<1). The silicon doping concentration gradually decreases starting at 3e¹⁸ cm⁻³ from the n-type lower cladding (1403) through the transition layers (1404-1405) to the lower GRIN layer (1406) where the silicon doping reaches 5e¹⁶ cm⁻³.

The undoped laser active area (1450) has a set of compressively strained AlGalInAs quantum wells (1408 and 14010), which are confined on each side by AlGaInAs barrier layers 1407,1409 and 1411 under tensile strain such that the strains compensate each other and the critical thickness for dislocations is neutralized. Here, two quantum wells (1408 and 14010) are shown each having a well thickness between 5 and 10 nm. The barrier layer thicknesses are between 5 nm and 10 nm for layers 1407, 1409, and 1411, respectively.

Next the upper GRIN separate confinement layer (GRINSCH) (1412), which is 40 nm thick beginning with AlxGa₍₁₋ₓ₎In_{0.53} (where 0.5<x<1) and ending with an interface layer of Al_{0.48}In_{0.52}As (1413), which is grown on top of the laser active area (1450) Included in layer 1413 is an additional layer of AI_{0.48}In_{0.52}As. The p-type Zn doping concentration gradually increased from 5e¹⁶ cm⁻³ or less as growth proceeds toward the completion of layer 1413. Where the concentration reaches 6e¹⁷ cm⁻³. Alternatively, a step index separate confinement heterostructure (SISCH) could be used in place of the GRIN SCH as confinement about the active area (1450).

Above the GRIN layer 1412-1413 is grown the upper cladding layer 1414 of thick p-type InP Zn-doped at a concentration starting at 1e¹⁷ cm⁻³. The layers 1412, 1413 and 1414 mirror the lower layers of 1404, 1405 and 1406 in optical index profile and form the bottommost monolithic laser diode (1453).

Above the upper cladding layer (1414) of the bottommost monolithic laser diode (1453), the tunnel junction layers (1415, 1516) are grown. Layer 1415 is 25 nm+100%/−75% InGaAs p-doped with Zinc or Carbon at concentration of 1e¹⁹ cm³. The P—InGaAs concentration could be any value between 5e¹⁸ cm⁻³ and 1e²⁰ cm⁻³. Layer 1416 is 25 nm+100%/−75% InGaAs N-doped with Silicon or Tellerium at concentration of 1e¹⁹ cm³. The P—InGaAs concentration could be any value between 5e¹⁸ cm⁻³ and 1e²⁰ cm⁻³.

Above the tunnel junction N—InGaAs layer (1416), the second monolithic laser (1454) is grown starting 1.5 micrometer thick N+ InP lower cladding layer (1417) with a silicon (Si) doping concentration of 3e¹⁸ cm⁻³ maximum is grown followed by a transition region 15 nm thick of lattice matched, graded AlxGa₍₁₋ₓ₎In_{0.53}As (where 0.5<x<1) to AI_{0.48}In_{0.52}As (1418-1419) into the separate confinement heterostructure (SCH) layers (1419-1427). Next is the lower graded-index (GRIN) layer (1420), which is 45 nm thick beginning with AI_{0.48}In_{0.52}As and ending with AlxGa₍₁₋ₓ₎In_{0.53}As (where 0.5<x<1). The silicon doping concentration gradually decreases from the n-type lower cladding (1417) through the transition layers (1418-1419) to the lower GRIN layer 14020, where the silicon doping reaches 5e¹⁶ cm⁻³.

The undoped laser active area (1451) has a set of compressively strained AlGaInAs quantum wells (1422 and 1424), which are confined on each side by AlGaInAs barrier layers 1421, 1423 and 1425 under tensile strain such that the strains compensate each other. Here, two quantum wells (1422, 1424) are shown, each having a well thickness between 5 nm and 10 nm. The barrier layers thicknesses are between 5 nm and 10 nm for layers 1421, 1423, and 1425, respectively.

Next the upper GRIN separate confinement layer (GRINSCH) (1426), which is 40 nm thick beginning with AlxGa₍₁₋ₓ₎In_{0.53} (where 0.5<x<1) and ending with an interface layer of AI_{0.48}In_{0.52}As (1427), which is grown on top of the laser active area (1451). Included in layer 1427 is an additional layer of AI_{0.48}In_{0.52}As. The p-type Zn doping concentration is gradually increased as growth start 5e¹⁶ cm⁻³ or less proceeds toward the completion of layer 1427, where the concentration reaches 6e¹⁷ cm⁻³. Alternatively, a step index separate confinement heterostructure (SI SCH) could be used in place of the GRIN SCH as confinement about the active area (1451).

Above the GRIN layer 1426-1427 is grown the upper cladding layer 1428 of 1.5 micrometer thick p-type InP Zn-doped at a concentration starting at 1e¹⁷ cm⁻³. The layers 1426, 1427, and 1428 mirror the lower layers of 1418, 1419 and 1420 in optical index profile and form the second monolithic laser diode (1454) about so the active area (1451).

Above the upper cladding layer 1428 of the second monolithic laser diode (1454), the tunnel junction layers 1429, 1430 are grown. Layer 1429 is 25 nm+100%/0/−75% InGaAs p-doped with Zinc or Carbon at concentration of 1e¹⁹ cm³. The P—InGaAs concentration could be any value between 5e18 cm³ and 1e²⁰ cm⁻³. Layer 1429 is 25 nm+100%/−50% InGaAs N-doped with Silicon or Tellurium at concentration of 1e¹⁹ cm³. The P—InGaAs concentration could be any value between 5e¹⁸ cm⁻³ and 1e²⁰ cm⁻³.

Above the tunnel junction N—InGaAs layer, the third monolithic laser (1455) is grown starting 1.5 micrometer thick N+ InP lower cladding layer (1431) with a silicon (Si) doping concentration of 3e¹⁸ cm⁻³ maximum is grown followed by a transition region 15 nm thick of lattice matched, graded AlₓGa₍₁₋ₓ₎In_{0.53}As (where (0.5<x<1) to AI_{0.48}In_{0.52}As (1432-1433) into the separate confinement heterostructure (SCH) layers 1433-1441. Next is the lower graded-index (GRIN) layer (1434), which is 45 nm thick beginning with AI_{0.48}In_{0.52}As and ending with (AlxGa₍₁₋ₓ₎In_{0.53}As (where 0.5<x<1). The silicon doping concentration gradually decreases from the n-type lower cladding (1431) through the transition layers (1432-1433) to the lower GRIN layer (1434), where the silicon doping reaches 5e¹⁶ cm³.

The undoped laser active area (1452) has a set of compressively strained AlGaInAs quantum wells (1436 and 1438), which are confined on each side by AlGaInAs barrier layers 1435, 1437 and 1439 under tensile strain such that the strains compensate each other. Here, two quantum wells 1436 and 1438 are shown each having a well thickness between 5 nm and 10 nm. The barrier layers thicknesses are between 5 nm and 10 nm for layers 1435, 1437, and 1439, respectively.

Next the upper GRIN separate confinement layer (GRINSCH) (1440), which is 40 nm thick beginning with (AlxGa₍₁₋ₓ₎In_{0.53} (where (0.5<x<1) and ending with an interface layer (1441) of AI_{0.48}In_{0.52}As, which is grown on top of the laser active area (1452). Included in layer 1441 is an additional layer of AI_{0.48}In_{0.52}As. The p-type Zn doping concentration is gradually increased as growth proceeds toward the completion of layer 1441, where the concentration reaches 6e¹⁷ cm⁻³. Alternatively, a step index separate confinement heterostructure (SISCH) could be used in place of the GRIN SCH as confinement about the active area (1452).

Above the GRIN layer (1440-1441) is grown the upper cladding layer (1442) of 1.5 micrometer thick p-type InP Zn-doped at a concentration starting at 1e¹⁷ cm⁻³ and preferably no more than 6e¹⁷ cm⁻³. The layers 1440, 1441, and 1442 mirror the lower layers of 1432, 1433 and 1434 in optical index profile and form the topmost monolithic laser diode (1455) about the active area (1452).

Above the upper cladding layer (1442) are the p-ohmic contact layers (1444-1447). Between the cladding layer 1442 and the contact layers 1444-1447, a 20 nm thick etch stop layer 1443 of p-Gaₓln₍₁₋ₓ₎As_{y}P_{(1-y)} (where 0.1<x<0.5 and 0.2<y<0.8) is grown in order to provide a controlled stopping depth for etching the ridge waveguide during the laser processing. The etch stop layer could be located at any position between the P-waveguide layer (1440) and the p-ohmic contact layers (1444-1447). Next a 1 micrometer thick p-InP layer (1444) Zn-doped is grown followed by a p-type GaInAsP layer (1445) Zn-doped and followed by InGaAs layer (1446), which will be the ohmic contact layer during laser processing. Finally, a capping layer of p-InP layer (1447) Zn doped is grown to complete the laser layer structure.

The detailed doping levels described are the preferred levels, but a range from 25% less to 50% more would be acceptable. The layer with doping higher than 1e¹⁸ cm⁻³ can range higher by factor of two or three as an acceptable range.

The layer thicknesses set forth above are the preferred embodiment, but a variation or 10% more or less is acceptable. The P-doping in the single monolithic laser diode is Zinc. Here, the probability that the zinc diffuse in the active area is high because of the multiple monolithic laser structure MOCVD growth time is long and growth MOCVD temperature is high. The Zinc diffusion in the active area causes wavelength shifts to lower wavelengths of the laser diode emission.

Zinc doping is modified in layers 1412, 1413 of bottommost monolithic laser diode in order to reduce and control the zinc diffusion in the active area 1450. Layers 1412 and 1413 zinc doping concentration is less than 1e¹⁷ cm⁻³.

Zinc doping is modified in layers 1426, 1427 of second monolithic laser diode in order to reduce and control the zinc diffusion in the active area 1451. Layers 1426 and 1427 zinc doping concentration is less than 1 e¹⁷ cm⁻³.

The tunnel junction P—InGaAs/N—InGaAs thickness is very thin such as 50 nm in order to eliminate the absorption losses in the tunnel junction.

The current spreading in multiple monolithic laser diodes is reduced by reducing the number of epitaxial layers. Except for the top monolithic laser, many layers are removed from the other monolithic laser diodes and some of these layers are thick layers. Removing thick layers reduces the current spreading in the multiple active areas (1450,1451,1452) of the multiple laser diodes (1453,1454,1455).

The device is preferably with the vertical current injection type semiconductor layers of the SCH and cladding doped p-type, and the other set of the SCH and cladding doped n-type. Lateral current confinement is achieved by either buried stripe geometry, or a ridge waveguide of raised ridge or dual trench formation. An alternative combination is implant isolation, or mesa isolation, whereby oxide depositions confine the current to the central region of the lateral optical confinement structure.

FIG. 16 shows two configurations for a high-power multi-junction semiconductor optical amplifier (1600). The p contact sections (1601 1606) are stripe openings or a shallow ridge structure to confine the current of the device. The first device is a simple straight section that can be a 4 μm, 5 μm, rib structure or a 10 μm, 20 μm, 30 μm or greater in width structure that will output a single mode when injected by a single mode laser source providing gain of 3 dB or greater at power levels of 1 Watt, 2 Watts, 3 Watts or greater. The input facet (1602) and the output facet (1603) are both low reflectivity coatings. In the second version (1606), the guided-contact section is tilted at an angle with respect to the normal to the input (1607) and output (1608) facets to reduce back reflections. The input to the device is tipped at an angle (1607) with respect to the normal to the input facet and can be 2°, 3°, 4° or more and the output is tipped at an angle of (1608) with respect to the normal to the output facet and is at the same angle as the input to the device. The straight section can be a 4 μm, 5 μm, rib structure or a 10 μm, 20 μm, 30 μm or greater in width structure that will output a single mode when injected by a single mode laser source.

FIG. 17 shows two configurations for a high-power multi-junction tapered semiconductor optical amplifier. The input facet to the device (1702) is coated with a low reflectivity coating. The straight section (1704) is a rib guide structure which forms a real index guide and can be 3 μm, 4 μm, or 5 μm or anything in between width or even greater. The end of the rib is a pair of deep trenches (1705) which create a diffracting aperture for the single mode propagating in the rib. The single mode exits the rib into a tapered gain guides section (1701) which allows the beam to expand and gain power. The taper can range from the nominal size of the rib, 3 μm, 4 μm, or 5 μm or anything in between to 10 μm, 20 μm, 30 μm or greater in width depending on the output power desired. The output facet (1703) and input facet (1702) are coated with a low reflectivity coating to suppress any unwanted parasitic modes from oscillating. A second version of this design is shown in the same figure. The input to the device (1702) is coated with a low reflectivity coating and the rib section is set at an angle (1711) of 4 degrees or more from the normal to the facet. The straight section (1704) is a rib guide structure which forms a real index guide and can be 3 μm, 4 μm, or 5 μm or anything in between width. The end of the rib is a pair of deep trenches (1705) which create a diffracting aperture for the single mode propagating in the rib. The single mode exits the rib into a tapered gain guides section (1701) which allows the beam to expand and gain power. The taper can range from the nominal size of the rib, 3 μm, 4 μm, or 5 μm or anything in between width to 10 μm, 20 μm, 30 μm or greater in width depending on the output power desired. The output facet (1703) is coated with a low reflectivity coating to suppress any unwanted parasitic modes from oscillating and is at an angle (1710) of 4 degrees or more with respect to the normal to the facet.

FIG. 18 is an example of a design suitable for a single junction semiconductor optical pre-amplifier. The input facet (1802)) of the device is coated with a low reflectivity coating and the rib can be either normal to the facet or angled (1804) at 4 degrees or more with respect to the normal to the facet. These features significantly reduce the facet's reflectivity effectively suppressing unwanted parasitic oscillations. The rib structure forms a real index guide and can be 3 μm, 4 μm, or 5 μm or anything in between width. The rib structure has multiple curves (1805) to further suppress unwanted modes from oscillating and improving the signal to noise ratio of the semiconductor optical amplifier. The output of the rib is coated with a low reflectivity coating (1806) and can be normal to the output facet or set at an angle (1806) of 4 degrees or more with respect to the normal to the facet. This device may also be produced with multiple junctions. The waveguide may also enter and exit from the same face forming a U or from perpendicular faces forming a half U bend.

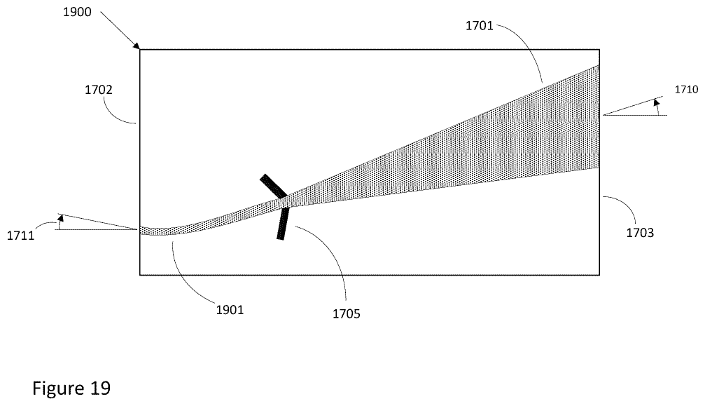

FIG. 19 shows a third configuration for a high-power multi-junction tapered semiconductor optical amplifier. The input facet to the device (1702) is coated with a low reflectivity coating. The input to the rib structure can be either normal the facet or set at an angle (1711) of 1 degree, 2 degrees, 3 degrees, 4 degrees or more with respect to the normal from the facet. The angle helps to suppress unwanted parasitic modes from oscillating. The rib is structure which forms a real index guide and can be 3 μm, 4 μm, or 5 μm or anything in between width. The rib in this design is shown with a bend (1901) for the purpose of suppressing unwanted modes from oscillating and enabling a different angle at the input and output facet. The end of the rib is a pair of deep trenches (1705) which create a diffracting aperture for the single mode propagating in the rib. The single mode exits the rib into a tapered gain guides section (1701) which allows the beam to expand and gain power. The taper can range from the nominal size of the rib, 3 μm, 4 μm, or 5 μm or anything in between width to 10 μm, 20 μm, 30 μm or greater in width depending on the output power desired. The output facet (1703) is coated with a low reflectivity coating to suppress any unwanted parasitic modes from oscillating and is at an angle (1710) of 1 degree, 2 degrees, 3 degrees, 4 degrees or more with respect to the normal to the facet. This high-power single mode semiconductor optical amplifier can be either a single junction or multi-junction design.

### REFERENCES

1) OSI Laser Diode Inc, CVD 68, CVD 167, www.laserdiode.com
2) I. I. Kim, B. McArthur, and E. Korevarr, “Comparison of laser beam propagation at 785 nm and 1550 nm in fog and haze for optical wireless communications,” Proceedings Vol. 4214, Optical Wireless Communications III; February 2001, https://doi.org/10.1117/12.417512
3) Analog Modules brochure, “Hybrid Eyesafe Laser Rangefinder Receiver”, Model 755A-03.1

What is claimed is:

1. A time-of-flight LiDAR system that uses a multi-junction laser diode as the laser source to provide higher peak power than a single junction laser diode and greater range where n>1.

2. The LiDAR system of claim 1 using a single transverse stripe with multi-junctions in the epi-layers to provide greater power and brightness than a single junction where n>1.

3. The LiDAR system of claim 1 where the multi-junction laser source can have a wavelength from 1225 nm to 1700 nm.

4. The LiDAR system of claim 1 that uses a polygon scanner to scan the transmitted laser beam and receive the transmitted laser beam producing a 3-dimensional representation of the field of view.

5. The LiDAR system of claim 1 that uses a Risley prism pair to scan the transmitted laser beam and receive the transmitted laser beam producing a 3-dimensional representation of the field of view.

6. The LiDAR system of claim 1 that uses a vibrating mirror to scan the transmitted laser beam and receive the transmitted laser beam producing a 3-dimensional representation of the field of view.

7. The LiDAR system of claim 1 that can be mounted on a rotating platform with either a Risley prism pair, a vibrating mirror or a polygon scanner to provide a 3-dimensional representation of the field of view.

8. The LiDAR system of claim 1 that determines the range of single object in the field of view.

9. The LiDAR system of claim 1 that can also double as a target designator.

10. The LiDAR system of claim 1 that uses an Avalanche Photo diode as a receiver.

11. The LiDAR system using a multi-junction laser diode of claim 1 that has a Bragg Grating etched on the top layer to control wavelength over a wide temperature range.

12. The LiDAR system using a multi-junction laser diode of claim 1 that uses a tapered semiconductor optical amplifier as the high-power laser transmitter.

13. The LiDAR system using a multi-junction laser diode of claim 1 that uses a tapered semiconductor optical amplifier as the high-power laser transmitter and a Bragg Grating stabilized master oscillator integrated on the same chip with feedback isolation trenches.

14. The LiDAR system of claim 1 uses multiple multi-junction laser diodes on a single chip where I is the number of laser diodes and I>1 to increase the output power of the source.

15. The LiDAR system of claim 1 uses multiple individually addressable multi-junction laser diodes on a single chip where I is the number of individually addressable laser diodes and I>1 to provide electronic beam steering.

16. The LiDAR system using a multi-junction laser diode of claim 1 that is integrated into a Silicon Photonic Integrated circuit to provide a complete LIDAR solution on a single chip.

17. The LiDAR system of claim 1 where the multi-junction laser diode uses a grating in an external cavity in Littrow to narrow and stabilize the wavelength of the laser source over a temperature range.

18. The LiDAR system of claim 1 that uses a MEMs device to steer the beam over the field of regard.

19. The LiDAR system of claim 1 that is configured as an optical phase array and is electronically steered over the field of view.

20. The LiDAR system of claim 1 that uses a micro-optic, a binary optic, a diffractive optic, a holographic optic, a micro-prism arrangement, or an Axicon to compensate for the displacement of the junctions from the axis of the primary collimating optic to create parallel, collimated output beams.

21. The LiDAR system of claim 1 using a Bragg Grating stabilized multi-junction source and a method to sample the master oscillator beam and mix it with the return beam to enable coherent detection on a double balanced receiver for the time-of-flight pulse.

22. The LiDAR system of claim 1 where a master oscillator is used to injection lock the multi-junction source creating mutually coherent beams from each laser of the multi-junction source.

23. The LiDAR system of claim 1 where the master oscillator, power splitting waveguide and power semiconductor optical amplifier are integrated on the same semiconductor material and the power semiconductor optical amplifier is independently biased from the master oscillator/power splitter section.
